(19) United States
(12) Patent Application Publication
(10) Pub. No.: US 2025/0184858 A1
(43) Pub. Date: Jun. 5, 2025

(54) DSCP MAPPING TO URSP INITIATED PDU SESSION

(71) Applicant: Telefonaktiebolaget LM Ericsson (publ), Stockholm (SE)

(72) Inventors: Robert SKOG, Hässelby (SE); Jan BACKMAN, Kärna (SE)

(73) Assignee: Telefonaktiebolaget LM Ericsson (publ), Stockholm (SE)

(21) Appl. No.: 18/852,438

(22) PCT Filed: May 4, 2022
(86) PCT No.: PCT/EP2022/062029

§ 371 Date: Sep. 27, 2024

(51) Int. Cl. H04W 40/12; H04W 28/02; H04W 76/10

(52) U.S. Cl. CPC H04W 40/12; H04W 28/0268; H04W 76/10

(57) ABSTRACT

A method, at a User Equipmentt (UE), for mapping packet traffic to a Protocol Data Unit (PDU) session initiated by a UE Route Selection Policy (URSP), based on Quality of Service (QoS) for the packet traffic. The method provides for receiving the packet traffic with a QoS parameter indicating a QoS to be applied to the packet traffic for uplink transmission of the packet traffic from the UE; and in response to receiving the packet traffic, associating the QoS parameter to a respective route selection policy from a plurality of route selection policies in the URSP to select a PDU session corresponding to the respective route selection policy; and mapping the packet traffic to the selected PDU session based on the QoS parameter.

### TECHNICAL FIELD

Embodiments of the disclosure relate to the field of communications; and more specifically, to the mapping of a Quality of Service (QoS) parameter to a Protocol Data Unit (PDU) session based on User Equipment Route Selection Policy (URSP) in a User Equipment (UE) for uplink packet traffic.

### BACKGROUND ART

The 3rd Generation Partnership Project (3GPP) unites a number of telecommunications standard developments, of which the 5^{th} Generation (5G) communications technology is the newest. 5G communications systems employ a new 5G core (5GC) and new radio access technology referred to as New Radio (NR). One of the changes with the deployment of the 5G systems is to accommodate flow based Quality of Service (QoS), where packets are classified and marked using QoS Flow Identifier (QFI), instead of mapping between a system core (e.g., Evolved Packet Core (EPC)) and radio bearers, which was the practice with 4^{th} Generation (4G) Long Term Evolution (LTE) communications systems. The 5G-NR system flows are mapped at the access network to radio bearers and multiple flows can exist. Furthermore, 5G systems allow for the implementation of network slicing, where packet traffic can be routed onto a network slice. A network slice is a logical network that provides specific network capabilities and network characteristics.

QoS is the description or measurement of the overall performance of a service, such as telephony, computer network, or cloud computing, and the performance seen by the users of the network. To quantitatively measure QoS, several related aspects of the network service are often considered, such as packet loss, bit rate, throughput, transmission delay, availability, jitter, etc.

Furthermore, in 3GPP, the QoS concept as used in 4G/LTE and 5G networks is class-based, where each carrier type is assigned one QoS Class Identifier (QCI) by the network. QCI is a mechanism used in LTE and 5G networks to ensure traffic is allocated appropriate QoS. Different traffic requires different QoS and therefore different QCI values. For example, QCI value 9 is typically used for a default carrier.

Currently in 5G communications systems, a 5G enabled User Equipment (UE) can be provisioned with UE Route Selection Policy (URSP) that provides information on which PDU session type a given service or application could use when activated to communicate with a packet core of the communications network. Typically, the URSP rule set is sent to the UE from a 3GPP network, such as a packet core, or some other source, to configure the UE to establish a set of PDU session types for packet traffic route selection. The UE uses the URSP information to identify which PDU session to send the packets uplink. Presently, the UE needs to know the requirements of the packet traffic in order to select the proper PDU session from multiple PDU sessions that are available to the UE. A problem arises if the UE is not aware of the QoS requirements of the packet traffic, because the UE cannot choose the desired PDU session to accommodate the QoS of the packet traffic. This situation may arise with some Application Clients (ACs) associated with the UE (e.g., generic ACs), but more likely when an external device is tethered to the UE.

To ensure that packet traffic is bound to the correct PDU session to meet QoS requirements when multiple PDU sessions are available for the UE, a mechanism is needed to provide the mapping of the packet traffic to a PDU session based on the policy information provided in the URSP according to the QoS.

### SUMMARY

Certain aspects of the present disclosure and their embodiments provide solutions to challenges noted above. In one aspect of the disclosed system, a method, at a User Equipment (UE) provides for mapping packet traffic to a Protocol Data Unit (PDU) session initiated by a UE Route Selection Policy (URSP) based on Quality of Service (QoS) for the packet traffic. The method further provides for: receiving the packet traffic with a QoS parameter indicating a QoS to be applied to the packet traffic for uplink transmission of the packet traffic from the UE; in response to receiving the packet traffic, associating the QoS parameter to a respective route selection policy from a plurality of route selection policies in the URSP to select a PDU session corresponding to the respective route selection policy; and mapping the packet traffic to the selected PDU session based on the QoS parameter.

In another aspect of the disclosed system, the UE receives the packet traffic from an Application Client (AC) resident on the UE.

In another aspect of the disclosed system, the UE receives the packet traffic from a device tethered to the UE.

In another aspect of the disclosed system, the QoS parameter is determined by device identification, type of device, or information related to the device when the device is tethered to the UE.

In another aspect of the disclosed system, the QoS parameter is Differentiated Services Code Point (DSCP).

In another aspect of the disclosed system, the PDU session is on a network slice.

In another aspect of the disclosed system, the data structure is a mapping table.

In another aspect of the disclosed system, the QoS parameter stored in the data structure is associated with returning downlink packet traffic associated with the selected PDU session to identify the QoS for the downlink packet traffic.

In another aspect of the disclosed system, multiple QoS parameters are associated with the selected PDU session.

In another aspect of the disclosed system, a UE provides for mapping packet traffic to a PDU session initiated by a URSP based on QoS for the packet traffic, wherein the UE is configured to: receive the packet traffic with a QoS parameter indicating a QoS to be applied to the packet traffic for uplink transmission of the packet traffic from the UE; in response to reception of the packet traffic, associate the QoS parameter to a respective route selection policy from a plurality of route selection policies in the URSP to select a PDU session corresponding to the respective route selection policy; and map the packet traffic to the selected PDU session based on the QoS parameter.

In another aspect of the disclosed system, a computer program containing instructions which, when executed on at least one processor, cause the at least one processor to carry out a method that provides for mapping packet traffic to a PDU session initiated by a URSP based on QoS for the packet traffic. The computer program provides for: receiving the packet traffic with a QoS parameter indicating a QoS to be applied to the packet traffic for uplink transmission of the packet traffic from the UE; in response to receiving the packet traffic, associating the QoS parameter to a respective route selection policy from a plurality of route selection policies in the URSP to select a PDU session corresponding to the respective route selection policy; and mapping the packet traffic to the selected PDU session based on the QoS parameter.

In another aspect of the disclosed system, a computer-readable storage medium has stored thereon a computer program which provides for mapping packet traffic to a PDU session initiated by a URSP based on QoS for the packet traffic. The computer program provides for: receiving the packet traffic with a QoS parameter indicating a QoS to be applied to the packet traffic for uplink transmission of the packet traffic from the UE; in response to receiving the packet traffic, associating the QoS parameter to a respective route selection policy from a plurality of route selection policies in the URSP to select a PDU session corresponding to the respective route selection policy; and mapping the packet traffic to the selected PDU session based on the QoS parameter.

There are, proposed herein, various embodiments which address one or more of the issues disclosed herein. Certain embodiments may provide one or more of the following technical advantage(s).

A solution disclosed herein works with existing URSP configuration of the UE, but allows QoS concepts (e.g., DiffServ) to be associated with a set of route selection policy (e.g., rules) to select a PDU session that fulfills QoS requirements of the packet traffic being sent uplink.

A solution disclosed herein allows tethering devices, as well as local applications to the UE, to send packet traffic uplink via a PDU session meeting certain QoS settings.

A solution disclosed herein allows the packet traffic to be sent on PDU sessions utilizing a network slice for 5G link or utilizing a bearer on 4G/LTE link.

A solution disclosed herein uses a QoS parameter, such as a DSCP value, to identify the packet traffic for associating the packet traffic to a PDU session that can provide the required QoS.

A solution disclosed herein allows a DSCP value to be mapped to a selected PDU session and the mapping stored for use in downlink to reinsert the DSCP value for the downlink packet traffic.

### BRIEF DESCRIPTION OF THE DRAWINGS

The embodiments of the disclosure may best be understood by referring to the following description and accompanying drawings. In the drawings:

FIG. 1 shows a 5G enabled UE communicating with a packet core, via a RAN, utilizing one or more PDU sessions in accordance with some embodiments of the present disclosure;

FIG. 2 shows a 5G enabled UE having a tethered external device communicating with a packet core, via a RAN, utilizing one or more PDU sessions in accordance with some embodiments of the present disclosure;

FIG. 3 shows a 5G communications system in accordance with some embodiments of the present disclosure;

FIG. 4 shows a table of DSCP values for use as a QoS parameter in accordance with some embodiments of the present disclosure;

FIG. 5 shows an example data structure linking a DSCP value to a PDU session in accordance with some embodiments of the present disclosure;

FIG. 6 shows a method for mapping a QoS parameter for packet traffic to a selected PDU session based on an associated route selection policy of the URSP in accordance with some embodiments of the present disclosure;

FIG. 7 shows a signalling diagram for uplink packet traffic in which the mapping of a QoS parameter to a selected PDU session is initiated by a client on the UE in accordance with some embodiments of the present disclosure;

FIG. 8 shows a signalling diagram for uplink packet traffic in which the mapping of a QoS parameter to a selected PDU session is initiated by an external device tethered to the UE in accordance with some embodiments of the present disclosure;

FIG. 9 shows a UE in accordance with some embodiments of the present disclosure; and

FIG. 10 shows a UE in accordance with some embodiments of the present disclosure.

### DETAILED DESCRIPTION

The following description describes methods and apparatus for Differentiated Services Code Point (DSCP) mapping to User Equipment Route Selection Policy (URSP) initiated Protocol Data Unit (PDU) session. However, the technique can be applied to other parameters or indicators. The following description describes numerous specific details such as operative steps, resource implementations, data structures, types of network functions, types of QoS indicators, and interrelationships of system components to provide a more thorough understanding of the present disclosure. It will be appreciated, however, by one skilled in the art that the embodiments of the present disclosure can be practiced without such specific details. In other instances, control structures, circuits, memory structures, system and/or network functions, and software instruction sequences have not been shown in detail in order not to obscure the present disclosure. Those of ordinary skill in the art, with the included descriptions, will be able to implement appropriate functionality without undue experimentation.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, model, or characteristic is described in connection with an embodiment, it is submitted that it is within the knowledge of one skilled in the art to implement such feature, structure, characteristic, or model in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in some embodiments of the present disclosure.

Some of the embodiments contemplated herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some of the embodiments contemplated herein apply to specific functions, data structures, radio access networks, etc., associated with 5G communications technologies or 4G/LTE. Some embodiments can employ different functions, structures, radio access networks, etc. The disclosure describes the use of DSCP as an example, however, other parameters or indicators can be employed. Some embodiments may apply other QoS parameters and/or indicators.

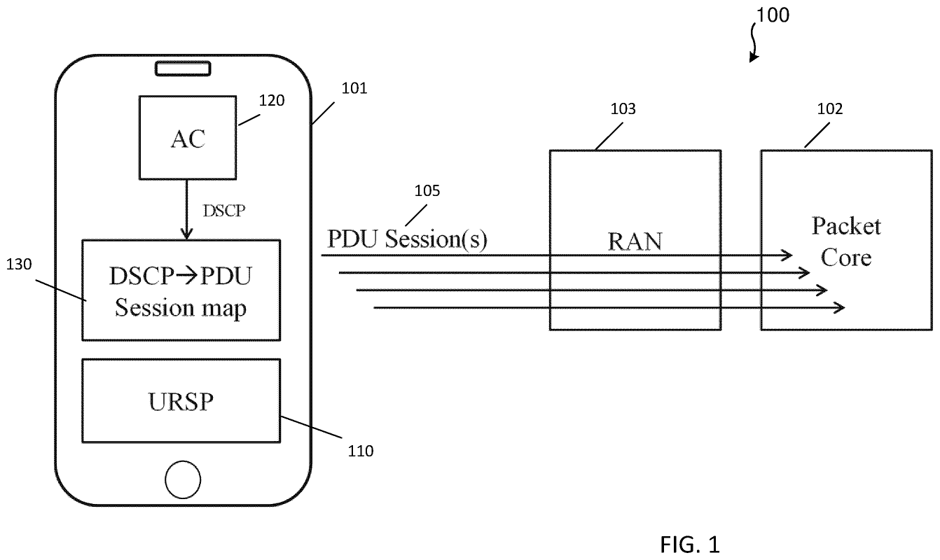

FIG. 1 shows a 5G enabled User Equipment (UE) communicating with a packet core, via a Radio Access Network (RAN), utilizing one or more Protocol Data Unit (PDU) sessions in accordance with some embodiments of the present disclosure. Communications system 100 includes a UE 101 communicating with a packet core 102 via a RAN 103. In some embodiments, the UE 101 is a 5G enabled terminal device capable of operating in the communications environment utilizing 3GPP standards and protocols established for 5G communication. The UE 101, although 5G enabled, can also be compatible to operate within a 4G/LTE communications system or connection.

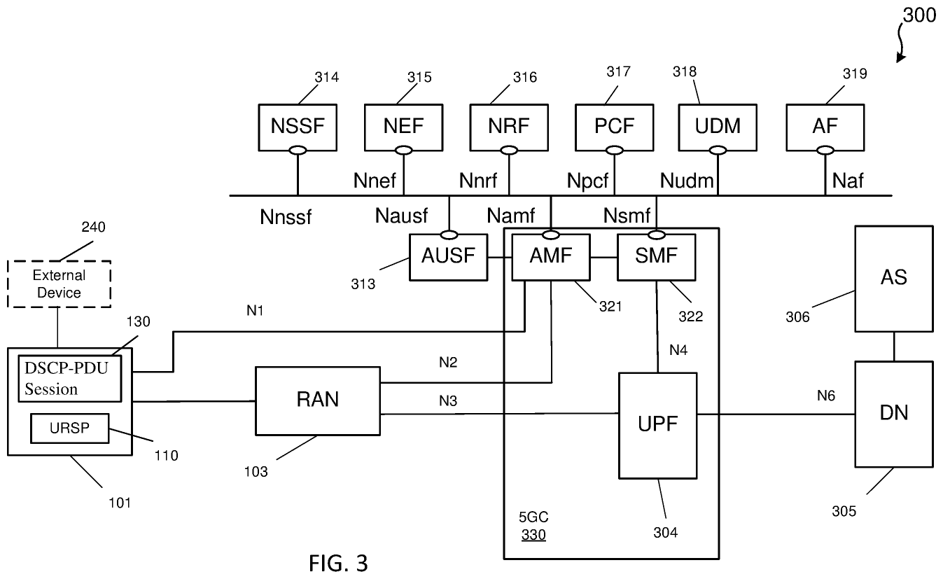

The packet core 102, when operating in the 5G environment, is referred to as a 5G Core (5GC). The packet core 102 and its attendant components of a 5G communications system are further described below in reference to FIG. 3. The RAN 103 communicates wirelessly with the UE 101 and, wired or wireless with the packet core 102. Thus, the RAN 103 provides a radio interface between the UE 101 and packet core 102. When the communications system 100 is a full 5G system, the RAN 103 is a 5G capable interface, such as NR. The 5G RAN interface may be referred to by other nomenclature, such as gNodeB (gNB).

FIG. 1 also illustrates an example of the communications system 100 having more than one PDU session between the UE 101 and the packet core 102. FIG. 1 illustrates a case where four different PDU sessions 105 are available between the UE 101 and the packet core 102. Four PDU sessions 105 are shown here as an example. The actual number can vary depending on the system operation or standard being deployed.

In a 5G system, such as the communications system 100, a network task is to establish one or more connectivity between the UE 101 and one or more Data Networks (DNs), via the packet core 102. As such, the UE 101 can request multiple PDU sessions in parallel, where each PDU session can have different capabilities and/or characteristics. When the communications system 100 is a fully operating 5G system with 5G-NR RAN for the RAN 103, the PDU sessions 105 can each be assigned to a network slice. A network slice is a logical network that provides specific network capabilities and network characteristics. Technical Specification 3GPP TS 23.501 provides one definition and use of network slice(s).

Multiple slices allow for different profiles and/or policies to operate in parallel and accommodate different applications to be run on the UE 101. For example, different policies can be set to align with each of the multiple PDU sessions 105 based on protocol type, traffic type, security, etc., in which each PDU session utilizes a separate network slice.

In order to manage the multiple PDU session on the different network slices, the 5G architecture uses a concept of UE Route Selection Policy (URSP). The URSP is a slice feature which informs the UE as to each slice status and, thus, the status of the PDU session on the respective network slice. The URSP is shown as URSP 110 for the UE 101. Therefore, a PDU session route selection policy can be configured dynamically via the URSP 110. Technical Specifications 3GPP TS 23.501 and 3GPP TS 23.503 define and describe procedures for using the URSP. The UE 101 can be provisioned with URSP information which provides information on which PDU session and network slice a given service or application should use when it is activated. The 5G network sends the URSP rules/policies to the UE 101 and the UE 101 uses this URSP information to know to which PDU session to send a given packet traffic.

FIG. 1 also shows an Application Client (AC) 120 associated with the UE 101. The AC 120 intends to send packet traffic utilizing one of the PDU sessions 105. In some instances, the UE 101 may have knowledge regarding the requirements for the packet traffic from the AC 120. In that instance, the UE may correlate the packet traffic requirements with a policy information in the URSP to select the required policy and the PDU session meeting the policy. However, in some instances, the UE may not have the information from the AC 120 to be able to correlate the requirements of the packet traffic to the policy information provided by the URSP 110.

In order to correlate the requirements of the packet traffic with the URSP to select the desired network slice and PDU session, the embodiments described in the disclosure introduce in the UE, a local rule-set that associates a Quality of Service (QoS) parameter for the packet traffic to a URSP policy rule (e.g., traffic category) to associate a PDU session on a network slice that meets the rule from multiple PDU sessions. In some embodiments, the QoS parameter used is the Differentiated Services Code Point (DSCP) values. In some embodiments, other QoS indicators can be used. By utilizing a QoS parameter set, a particular QoS parameter can be associated with a URSP policy rule, in order to select the PDU session corresponding to the URSP policy rule.

Accordingly, as shown in FIG. 1, the AC 120 uses a DSCP value in the uplink for packet traffic to indicate the QoS. Although different embodiments may employ different QoS parameters and data structures, in some embodiments DSCP is used for the QoS parameter. Differentiated Services (DiffServ) is a networking architecture mechanism for classifying and managing network traffic and providing QoS on IP networks. DiffServ uses a 6-bit DSCP in the 8-bit Differentiated Services (DS) field in the IP header for packet classification. DiffServ relies on a mechanism to classify and mark packets as belonging to a specific class. DiffServ-aware routers implement per-hop behaviors (PHBs), which define the packet-forwarding properties associated with a class of traffic. Different PHBs may be defined to offer, for example, low-loss or low-latency service. Rather than differentiating network traffic based on the requirements of an individual flow, DiffServ operates on the principle of traffic classification, placing each data packet into one of a limited number of traffic classes.

The DSCP value is associated with a route selection policy from a set of policy rules in the URSP 110 to select the respective PDU session for the packet traffic and the traffic is mapped to the selected PDU session. The DSCP-to-PDU session correlation can be stored in a data structure 130, such as a memory, in order to retain the DSCP-to-PDU session map information. In some embodiments, configuration of the DSCP-to-PDU session map information can be provided to the UE 101 prior to or during set-up of the PDU sessions by the packet core 102, or some other management node. In some embodiments, the DSCP-to-PDU session map information can be provided when initiating a packet transfer. The use of the DSCP-to-PDU session map information in a data structure allows existing URSP policies to be correlated to DSCP values without modifying the URSP. However, in some embodiments, the DSCP-to-PDU session map information can be incorporated in the URSP itself.

By mapping a QoS parameter sent by the AC 120 to the appropriate PDU session capable of handling the QoS requirement, packet traffic can be correctly routed uplink from the UE 101. By employing the disclosed technique, an operating system of the UE 101 can allow a generic application infrastructure to be used independently if the application is running locally. For example, the UE 101 can allow portable applications and not necessarily rely on the use of Application Programming Interfaces (APIs).

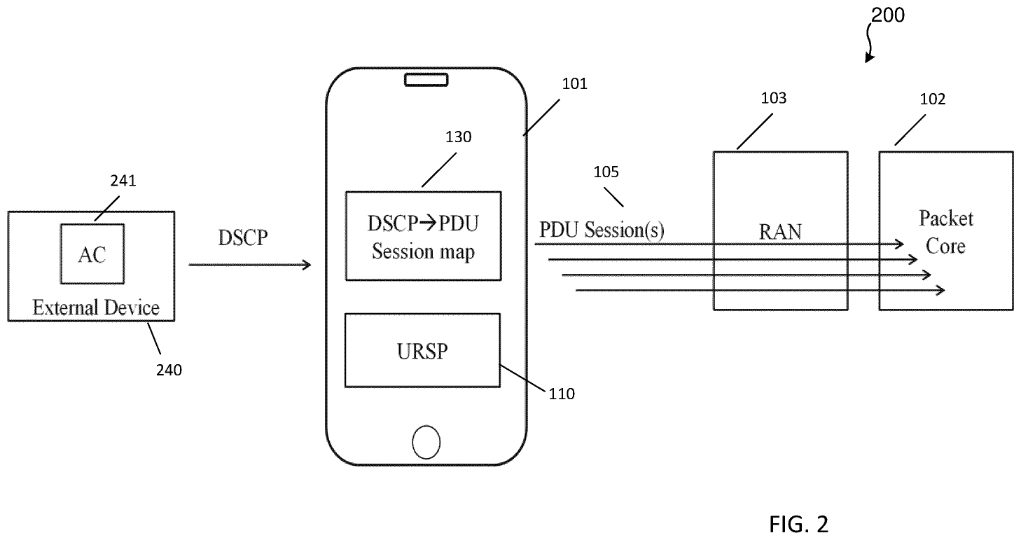

FIG. 2 shows a 5G enabled UE having a tethered external device communicating with a packet core, via a RAN, utilizing one or more PDU sessions in accordance with some embodiments of the present disclosure. FIG. 2 illustrates a variant from the embodiment of FIG. 1, in that instead of a local AC 120, an external device 240 is tethered to the UE 101 in communications system 200. The tethered connection can be a wired or wireless connection, such as a Bluetooth™ connection, to provide communications between the external device 240 and the UE 110. An example of a tethered external device is a virtual reality (VR) goggle or an augmented reality (AR) goggle. The external device 240 may have its AC 241 operating on the device.

When connected to the UE 101, the external device 240 sends a QoS parameter (e.g., a DSCP value) with the uplink packet traffic to the UE 101. A problem with a tethered device is that the UE may not be able to assess the packet requirements to perform the correct mapping of traffic from the tethered device. However, by sending a DSCP value to the UE 101 with the packet traffic, the UE 101 can use the DSCP value to select the correct PDU session.

In some instances, the communications systems 100 and/or 200 of FIGS. 1 and 2 may use a 4G/LTE RAN to communicate between a 5G enabled UE and a 5G packet core. In those instances, a 4G/LTE RAN 103 would not be able to apply network slices. Accordingly, in this instance, different PDU sessions would be carried on separate bearers between the UE 101 and the packet core 102. However, the UE would still employ the DSCP-to-PDU session mapping to obtain the correct bearer for the selected PDU session.

Furthermore, as an alternative, instead of the external device 240 sending the DSCP value to the UE 101 with the packet traffic, the external device may send some other indicator by identifying to the UE 101 a specific entity identifier. For example, the external device (such as an AR goggle) when tethered could identify itself by device identification, type of device and/or information related to the device. For example, an AR goggle could identify itself to the UE by sending information that informs the UE that the tethered device is an AR goggle. The UE can take that information and determined that the goggle requires a specific DSCP value to meet its QoS requirement and select the PDU session corresponding that DSCP value.

FIG. 3 shows a 5G communications system in accordance with some embodiments of the present disclosure. FIG. 3 shows a 5G communications system 300 as depicted in 3GPP Technical Specification (TS) 23.501 with a 5G Core (5GC) 330 and associated network functions 313-319. The 5G communications system 300 is a more detailed illustration of the communications systems of FIG. 1 and FIG. 2. The RAN for the 5G system 300 can be the afore-mentioned NR (e.g., gNodeB or gNB). The 5GC 330 correlates to the packet core 102. The 5G communications system 300 also connects to a Data Network (DN) 305, such as the Internet. The RAN 103 connects to a User Plane Function (UPF) 304 using interface N3 and the UPF 304 connects to the DN 305 using interface N6. The UPF 304 is a service function that processes user plane packets, which processing may include altering the packet's payload and/or header, providing interconnections, routing the packet, etc.

The base components of 5GC 330 are the UPF 304, an Access and Mobility Function (AMF) 321 and a Session Management Function (SMF) 322. Working with the 5GC components are various other network functions of the 5G communications system 300. The shown functional units are an Authentication Server Function (AUSF) 313 for storing data for authentication of a user device, a Network Slice Selection Function (NSSF) 314 for handling network slicing, a Network Exposure Function (NEF) 315 for exposing capabilities and events, a Network Repository Function (NRF) 316 for providing discovery and registration functionality for Network Functions (NFs), a Policy Control Function (PCF) 317, Unified Data Management (UDM) 318 for storing subscriber data and profiles, and an Application Function (AF) 319 for supporting specific applications and application influence on traffic routing.

The base components of the 5GC 330 are the core network control plane functions configured to provide mobility management in the form of the AMF 321 for providing UE based authentication, authorization, mobility management, etc.; a core network control plane function configured to provide session management in the form of the SMF 322 configured to perform session management, e.g. session establishment, modify and release; and the UPF 304. The configuration of various components/functions shown in FIG. 3 are examples only and other embodiments may have other configurations, including different set of components/functions.

The URSP 110 is enabled by the PCF 317 and the network slice status is sent to the UE via the AMF 321 via interface N1. The PDU session from the UE 101 to the DN 305 is via the UPF 304. The DN 305 may connect to other components such as the shown Application Server (AS) 306. As noted above, when system 300 is a complete 5G system, network slicing capability allows for a PDU session to be carried on a network slice. However, if the RAN is not enabled for 5G (e.g., is 4G/LTE), then the PDU sessions are carried on bearers,

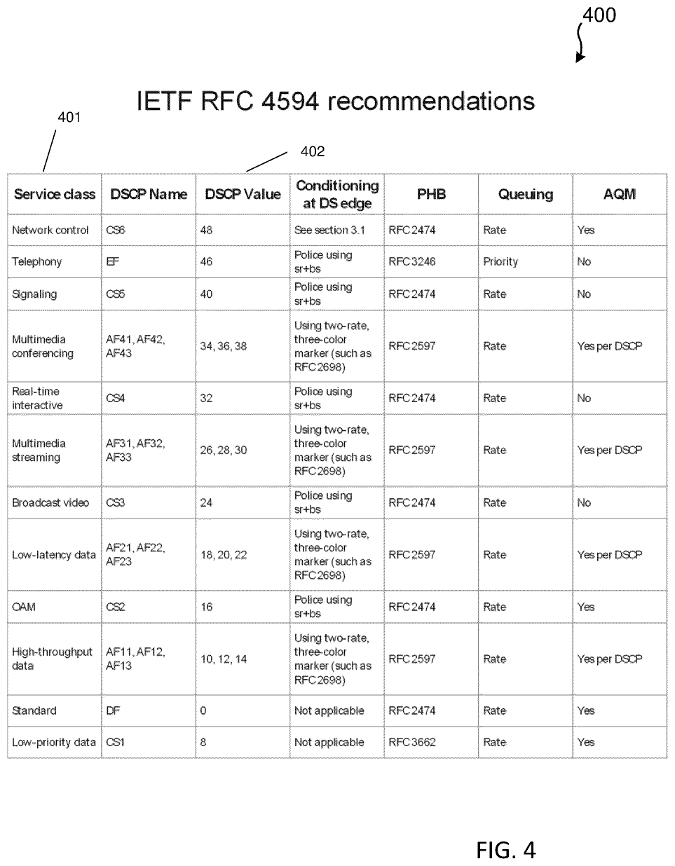

FIG. 4 shows a table 400 of DSCP values for use in accordance with some embodiments of the present disclosure. FIG. 4 shows a recommendation chart 400 by the Internet Engineering Task Force (IETF) Request For Comments (RFC) document 4594 (RFC 4594) for DSCP, showing the service class 401 and DSCP values 402, along with other details. In implementing the DSCP for the QoS parameter described above, the scheme allows a local application or a tethered device to use a DSCP value in the uplink packet traffic to indicate the QoS.

The use of DSCP allows the functionality of using existing 3GPP mechanisms for QoS, while at the same time allows the local application or the tethered device to indicate the desired behavior in accordance with the IETF standardized DSCP marking. Accordingly, the UE, by associating the QoS value to the set of policies of the URSP, can select the appropriate PDU session for the noted DSCP value. A separate mapping can be obtained for each available PDU session.

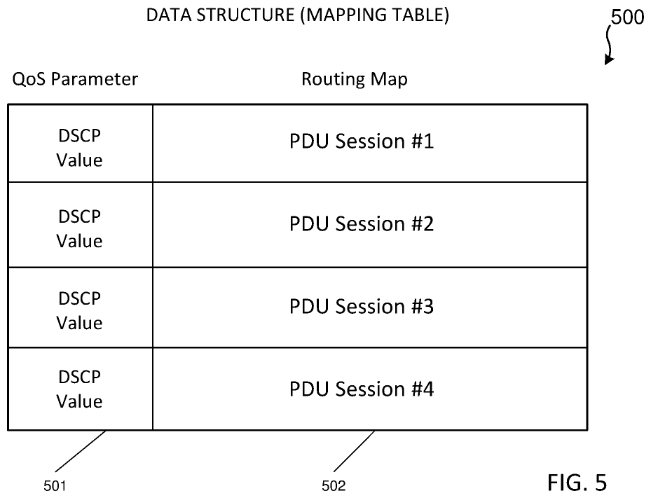

FIG. 5 shows an example data structure linking a DSCP value to a PDU session in accordance with some embodiments of the present disclosure. The data structure 500 shown is used as part of the earlier described data structure 130. Thus, in some embodiments, data structure 500 is a mapping table. The data structure can be stored in a memory or some other storage device of UE 101. In some embodiments, the data structure 500 can be stored external to the UE 101. This linking of the DSCP value as a QoS parameter 501 to the selected PDU session 502 is illustrated in FIG. 5. Four mappings are shown to exemplify the four PDU sessions illustrated in FIG. 1 and FIG. 2. Some embodiments may have less or more than the four shown. In some embodiments, more than one DSCP value can be mapped to the same PDU session. That is, multiple DSCP values are associated with a particular PDU session. This may occur when more DSCP values are used than the number of PDU sessions. Furthermore, a PDU session may be designated as a default PDU session.

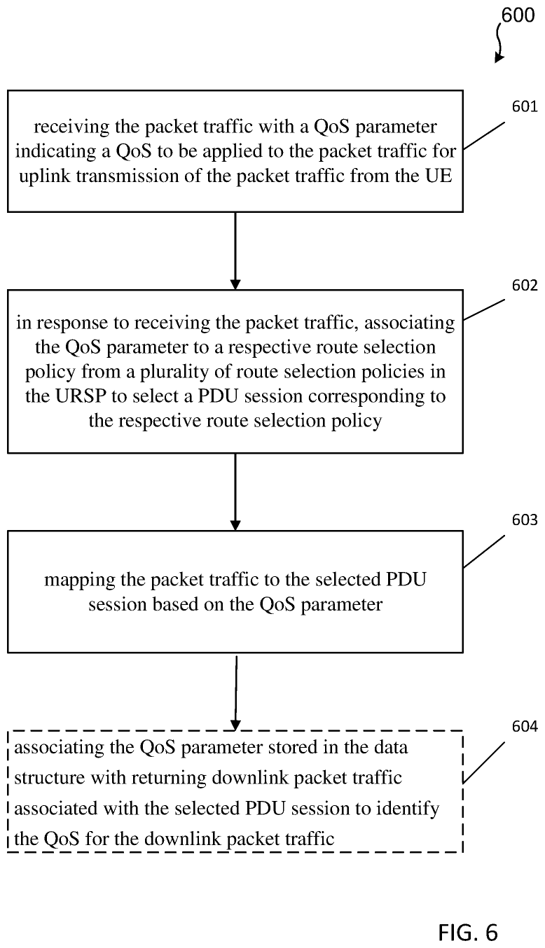

FIG. 6 shows a method for mapping a QoS parameter for packet traffic to a selected PDU session based on an associated route selection policy of the URSP in accordance with some embodiments of the present disclosure. A method 600, at a UE provides for mapping packet traffic to a PDU session initiated by a URSP based on QoS for the packet traffic. The method 600 performs steps 601-603 as noted below. The method is performed at a UE, such as UE 101.

At step 601, the UE receives the packet traffic with a QoS parameter indicating a QoS to be applied to the packet traffic for uplink transmission of the packet traffic from the UE. At step 602, in response to receiving the packet traffic, the UE associates the QoS parameter to a respective route selection policy from a plurality of route selection policies in the URSP to select a PDU session corresponding to the respective route selection policy. At step 603, the UE maps the packet traffic to the selected PDU session based on the QoS parameter.

At an optional step 604, the UE. associates the QoS parameter stored in the data structure with returning downlink packet traffic associated with the selected PDU session to identify the QoS for the downlink packet traffic. This operation can be performed when there is a desire to attach the QoS parameter to the downlink packet traffic. In some instances, with tethered devices, there can be an advantage in sending a DSCP value back to identify the QoS of the downlink traffic.

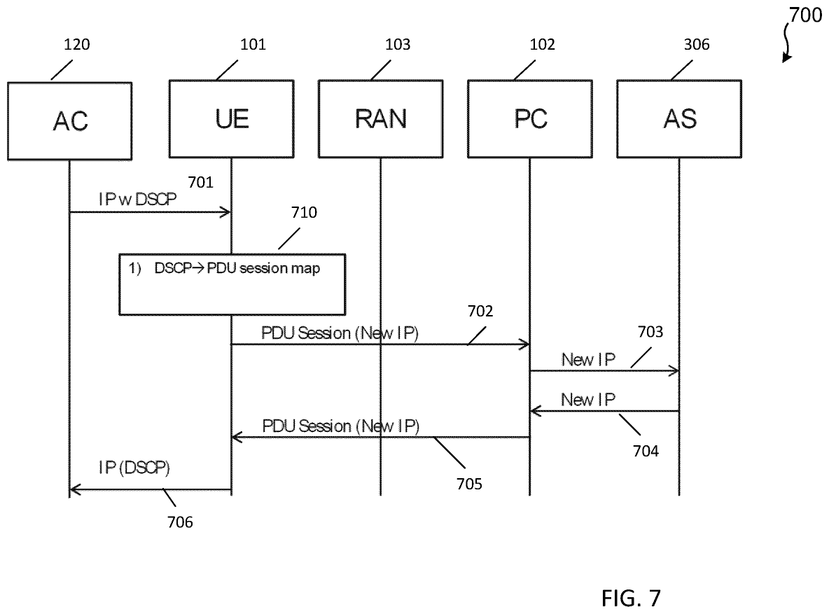

FIG. 7 shows a signalling diagram 700 for uplink packet traffic in which the mapping of a QoS parameter to a selected PDU session is initiated by a client on the UE in accordance with some embodiments of the present disclosure. Diagram 700 applies to the embodiment shown in FIG. 1 where there is a local AC 120 for the UE 101. In some embodiments, the packet core 102 can be 5GC 330 which connects to the AS 306. In some embodiments, the method 600 of FIG. 6 applies to the diagram 700.

As shown in diagram 700, at operation 701 the AC 120 sends packet traffic with the agreed DSCP marking for the traffic class it wants to use. The UE 101 looks up the traffic to determine if the DSCP to Traffic Class maps to a URSP rule. If there is a map to an existing URSP rule, the PDU session that the URSP rule points to is used at operation 710. The Internet Protocol (IP) address of the PDU session is bound to the packet and sent to the packet core 102 at operation 702. At operation 703 the packet traffic is routed from the packet core (e.g., UPF 304 of 5GC 330) to the AS 306.

The application sends a response towards the UE at operation 704 that is transported via the packet core 102 and RAN 103 to the UE 101 at operation 705. When the packet is arriving, it is possible to restore the stored DSCP value at the UE 101, if desired, prior to sending the packet to the AC 120.

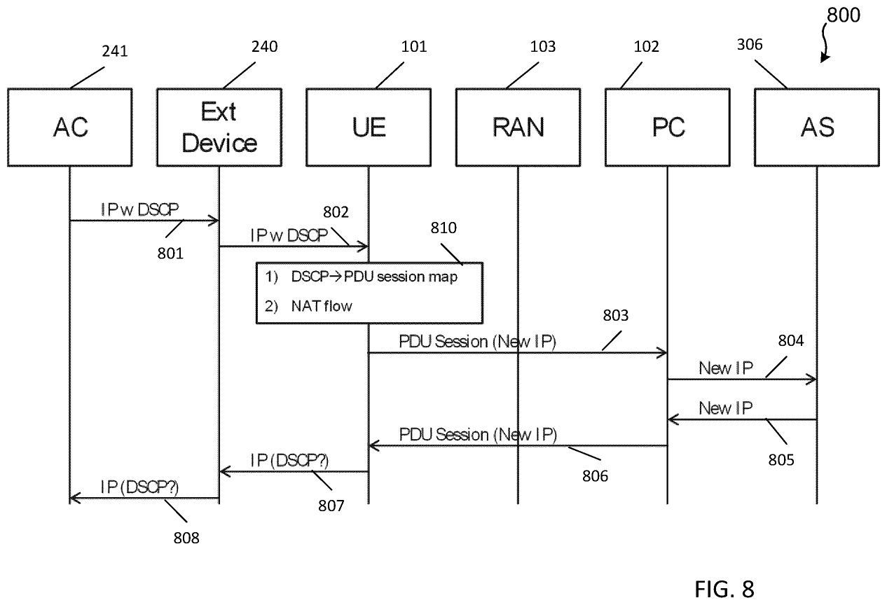

FIG. 8 shows a signalling diagram for uplink packet traffic in which the mapping of a QoS parameter to a selected PDU session is initiated by an external device tethered to the UE in accordance with some embodiments of the present disclosure. Diagram 800 applies to the embodiment shown in FIG. 2 where there is an external device (e.g., device 240) tethered to the UE 101. The external device may have its own AC 241. In some embodiments, the packet core 102 can be 5GC 330 which connects to the AS 306. In some embodiments, the method 600 of FIG. 6 applies to the diagram 800.

As shown in diagram 800, AC 241 in the external device 240 sends traffic with the agreed DSCP marking for the traffic class it wants to use in operation 801. The external device sends the traffic to the UE in operation 802. The UE 101 looks up the traffic to see if the DSCP to Traffic Class maps to a URSP rule. If there is a map to an existing URSP rule, the PDU session that the URSP rule points to is used at operation 810. Also, the packet is network address translated (NATed) to use the IP address of that PDU session. The packet is sent to the packet core 102 at operation 803. From the packet core (e.g., UPF 304 of 5GC 330), the packet traffic is routed to the AS 306 at operation 804.

The AS 306 sends a response towards the UE that is transported via the packet core 102 and RAN 103 to the UE 101 at operations 805-806. When the packet is arriving at the UE the network address translation (NAT) table is consulted to recreate the IP address in the tethered device. When this is done, it is also possible to restore the DSCP value (in case the connection to the application has any benefit of that, which may be the case when the UE is used as a network address translating router for a network) and the packet is routed to the external device 240 at operation 807. At operation 808, the packet is sent from the external device 240 to the AC 241.

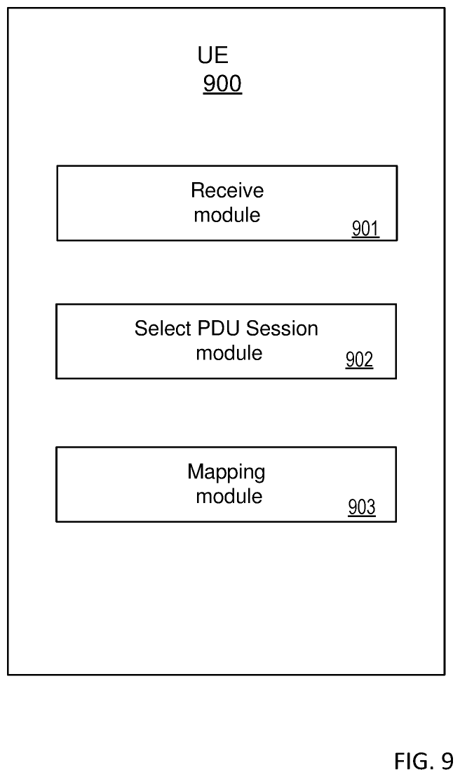

FIG. 9 shows a UE in accordance with some embodiments of the present disclosure. In some embodiments, the UE 900 can implement the functions of the method 600 of FIG. 6, as well as the various embodiments described in the disclosure. As shown, a Receive module 901 can perform operations corresponding to the operations of step 601 of FIG. 6. A Select PDU Session module 902 can perform operations corresponding to the operations of step 602. A Mapping module 903 can perform operations corresponding to the operations of step 603. The Mapping module 903 can also perform operations corresponding to step 604. The UE 900 may contain other functional elements that are not shown.

In some embodiments, the modules 901-903 can be provided as a computer program product, or software, that can include a machine-readable medium having stored thereon instructions, which can be used to program a computer system (or other electronic device) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In some embodiment, the modules of the UE 900 are implemented in software. In other embodiments, the modules of the UE 900 are implemented in hardware. In further embodiments, the modules of the UE 900 are implemented in a combination of hardware and software. In some embodiments, the computer program can be provided on a carrier, where the carrier is one of an electronic signal, optical signal, radio signal or computer storage medium.

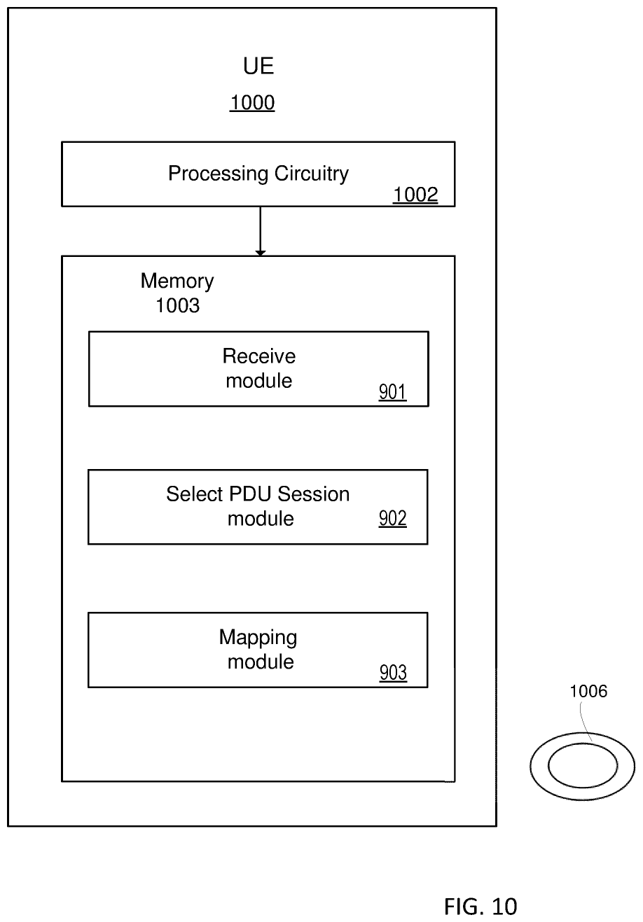

FIG. 10 shows a UE in accordance with some embodiments of the present disclosure. The UE 1000 can implement the functions of the method 600 of FIG. 6, as well as the various embodiments described in the disclosure. In some embodiments, the UE 1000 can be configured to implement the modules 901-903 of FIG. 9, wherein the instructions of the computer program for providing the functions of modules 901-903 reside in a memory 1003.

The UE 1000 comprises processing circuitry (such as one or more processors) 1002 and a non-transitory machine-readable medium, such as the memory 1003. The processing circuitry 1002 provides the processing capability. The memory 1003 can store instructions which, when executed by the processing circuitry 1002, are capable of configuring the UE 1000 to perform the methods described in the present disclosure. The memory can be a computer readable storage medium, such as, but not limited to, any type of disk 1006 including magnetic disks, optical disks, CD-ROMs, and magnetic-optical disks, read-only memories (ROMs), random access memories (RAMs), EPROMs, EEPROMs, magnetic or optical cards, or any type of media suitable for storing electronic instructions. Furthermore, a carrier containing the computer program instructions can also be one of an electronic signal, optical signal, radio signal or computer storage medium.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Furthermore, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

1. A method, at a User Equipment (UE), for mapping packet traffic to a Protocol Data Unit (PDU) session initiated by a UE Route Selection Policy (URSP), based on Quality of Service (QoS) for the packet traffic, the method comprising:
receiving the packet traffic with a QoS parameter indicating a QoS to be applied to the packet traffic for uplink transmission of the packet traffic from the UE;
in response to receiving the packet traffic, associating the QoS parameter to a respective route selection policy from a plurality of route selection policies in the URSP to select a PDU session corresponding to the respective route selection policy; and
mapping the packet traffic to the selected PDU session based on the QoS parameter.

2. The method according to claim 1, wherein the receiving the packet traffic comprises receiving the packet traffic from an Application Client (AC) resident on the UE.

3. The method according to claim 1, wherein the receiving the packet traffic comprises receiving the packet traffic from a device tethered to the UE.

4. The method according to claim 3, wherein the QoS parameter is determined by device identification, type of device, or information related to the device when the device is tethered to the UE.

5. The method according to claim 1, wherein the QoS parameter is Differentiated Services Code Point (DSCP).

6. The method according to claim 1, wherein the PDU session is on a network slice.

7. The method according to claim 1, wherein a mapping table is used to map the packet traffic to the selected PDU session based on the QoS parameter.

8. The method according to claim 1, further comprising associating the QoS parameter stored in a data structure with returning downlink packet traffic associated with the selected PDU session to identify the QoS for the downlink packet traffic.

9. The method according to claim 1, wherein multiple QoS parameters are associated with the selected PDU session.

10. A User Equipmentt (UE) for mapping packet traffic to a Protocol Data Unit (PDU) session initiated by a UE Route Selection Policy (URSP), based on Quality of Service (QoS) for the packet traffic comprising:
one or more processors; and
a memory comprising instructions which, when executed by the one or more processors cause the UE to:
receive the packet traffic with a QoS parameter indicating a QoS to be applied to the packet traffic for uplink transmission of the packet traffic from the UE;
in response to reception of the packet traffic, associate the QoS parameter to a respective route selection policy from a plurality of route selection policies in the URSP to select a PDU session corresponding to the respective route selection policy; and
map the packet traffic to the selected PDU session based on the QoS parameter.

11. The UE according to claim 10, wherein the reception of the packet traffic comprises reception of the packet traffic from an Application Client (AC) resident on the UE.

12. The UE according to claim 10, wherein the reception of the packet traffic comprises reception of the packet traffic from a device tethered to the UE.

13. The UE according to claim 12, wherein the QoS parameter is determined by device identification, type of device, or information related to the device when the device is tethered to the UE.

14. The UE according to claim 10, wherein the QoS parameter is Differentiated Services Code Point (DSCP).

15. The UE according to claim 10, wherein the PDU session is on a network slice.

16. The UE according to claim 10, wherein a mapping table is used to map the packet traffic to the selected PDU session based on the QoS parameter.

17. The UE according to claim 10, wherein the UE is further configured to associate the QoS parameter stored in a data structure with returning downlink packet traffic associated with the selected PDU session to identify the QoS for the downlink packet traffic.

18. The UE according to claim 10, wherein multiple QoS parameters are associated with the selected PDU session.

19. A non-transitory computer readable storage medium comprising instructions which, when executed on at least one processor, cause a User Equipment (UE) for mapping packet traffic to a Protocol Data Unit (PDU) session initiated by a UE Route Selection Policy (URSP), based on Quality of Service (QoS) for the packet traffic, to perform operations comprising:
receiving the packet traffic with a QoS parameter indicating a QoS to be applied to the packet traffic for uplink transmission of the packet traffic from the UE;
in response to receiving the packet traffic, associating the QoS parameter to a respective route selection policy from a plurality of route selection policies in the URSP to select a PDU session corresponding to the respective route selection policy; and
mapping the packet traffic to the selected PDU session based on the QoS parameter.

20. (canceled)

21. The non-transitory computer readable storage medium according to claim 19, wherein the receiving the packet traffic comprises receiving the packet traffic from an Application Client (AC) resident on the UE; or receiving the packet traffic from a device tethered to the UE.
